(19) United States
(12) Patent Application Publication
(10) Pub. No.: US 2025/0303862 A1
(43) Pub. Date: Oct. 2, 2025

(54) VEHICLE- BASED CONVERSATIONAL ARTIFICIAL INTELLIGENCE

(71) Applicant: Sony Group Corporation, Tokyo (JP)

(72) Inventors: Tatsuya Yamazaki, Kanagawa (JP); Hirokazu Hashimoto, Kanagawa (JP); Takashi Kamata, Tokyo (JP); Tatsuhiro Kitagawa, Tokyo (JP); Ryota Sakakura, Kanagawa (JP); Takanori Kubota, Kanagawa (JP); Shouichi Doi, Kanagawa (JP); Tonni Sandager Larsen, San Diego, CA (US)

(73) Assignee: Sony Group Corporation, Tokyo (JP)

(21) Appl. No.: 18/883,459

(22) Filed: Sep. 12, 2024

Related U.S. Application Data
(60) Provisional application No. 63/571,670, filed on Mar. 29, 2024.

(51) Int. Cl. B60K 35/26; G06V 20/59

(52) U.S. Cl. CPC B60K 35/265; G06V 20/59

(57) ABSTRACT

A vehicle conversation system is provided to provide AI generated conversation talk in a personalized and secure manner for a user in a vehicle. The conversation system can combine multiple conversational AI services, creating an interactive experience that remains engaging over time, for example by changing topics according to user mood, driving conditions, and/or user preferences. A central subset AI unit may include one or more AI models to generate content, such as prompts, and provide overseeing of components, e.g. AI communicators, as well as interface with external AI services. The conversation system further provides for various levels of protection of user sensitive information, such anonymizing user information by a zero knowledge proof method, storing information in a blockchain, and cleansing prompts of user sensitive information.

### CROSS REFERENCES TO RELATED APPLICATIONS

This application claims the benefit of the filing date of U.S. Provisional Patent Application No. 63/571,670, filed Mar. 29, 2024, the disclosure of which is hereby incorporated herein by reference for all purposes.

### BACKGROUND

Traditional entertainment provided in vehicles is primarily restricted to passive forms like playing a radio, podcast, and music. A driver, who aside from selecting audio content, simply receives information without active engagement. In-vehicle entertainment is often limited due to the need for a driver to focus on the action of driving with only brief idle moments when the vehicle is stationary. Modes of entertainment in vehicles must accommodate a driver's need to avoid distraction away from the road. Some entertainment can benefit a driver to stay alert, such as during long stretches of driving or commuting. Further, as vehicle technology matures to allow for more autonomous driving, in-vehicle entertainment forms should likewise evolve.

Devices that employ artificial intelligence (hereinafter, “AI”) services e.g., chatbots and virtual agents, may be programmed to engage in conversation interactions with a person. AI services currently used in vehicles provide just the necessary information in response to triggers by the driver. The driver may initiate the AI service by asking a question, requesting to troubleshoot a problem, or asking the AI service to perform other tasks. Some AI platforms, such as Google Assistant and Amazon Alexa, presently serve as voice user interfaces, such as selecting desired information or music rather than provide more engaging entertainment. There is interest in expanding modes of entertainment for drivers and passengers in vehicles.

### SUMMARY

A vehicle conversation system (also called “vehicle conversation system”, “conversation system”, or simply “system”) is provided that provides AI generated conversational talk in a personalized and secure manner for a user in a vehicle. The conversation system can combine multiple conversational AI services, creating an interactive experience that remains engaging over time. Conversation topics can be changed over time according to user mood, driving conditions, and/or user preferences. A central subset AI unit may include one or more AI models to generate content and provide overseeing of components, e.g. AI communicators, of the conversation system, as well as interface with external AI services. The conversation system further provides for various levels of protection of user sensitive information, such anonymizing user information by a Zero Knowledge Proof (ZKP) method, storing information in a blockchain, and cleansing prompts of user sensitive information.

A vehicle conversational AI method is provided that is implemented by one or more computers in which a user category that characterizes a user is determined and the determination is made based, at least in part, on anonymized user information. A first conversation topic is also determined from a topic output of a subset AI unit that applies generalization rules for the user category, in-vehicle conversation information, and event information. Based, at least in part, on the user category and the first conversation topic, a first clean prompt is created to receive first enhancement information from a selected first external AI service. A first speech associated with the first conversation topic is generated using the first enhancement information. The first speech is used for output in a vehicle by a first AI communicator.

In some aspects of the method, the first speech is AI generated by using as input the user category, the in-vehicle conversation information, and the event information.

In other aspects of the method, a second (or more) external AI service(s) may be selected by the subset AI unit from a plurality of external AI services, as applicable to the first conversation topic and the user category. To retrieve second enhancement information, a second clean prompt may be created for the second external AI service. This additional second enhancement information may also be applied to first speech generation prior to outputting the first speech.

In some implementations, the conversation system may receive a user response to output of the first speech. Based, at least in part, on the user response, a second conversation topic may be determined. The in-vehicle conversation may be shifted by outputting a generated second speech associated with the second conversation topic.

In some cases, information protection/security may be facilitated by user information and vehicle information by applying a zero knowledge proof method to anonymize this information and the user information and the vehicle information may be stored in a blockchain.

In some implementations, the method may include determining a personality type for the first AI communicator suitable to interact with the user, based, at least in part, on the user category, the in-vehicle conversation information, and the event information. The first speech may be generated to correspond with the personality type of the AI communicator.

In another aspect of the method additional AI communicators may also be created. Each AI communicator may have its own determined individual personality type. Additional speech may be generated for the in-vehicle conversation corresponding to the respective individual personality type of the associated AI communicator. The additional speech may be outputted by individual of the respective additional AI communicators.

In still some implementations, a feedback user interface may be employed to receive user feedback in real time during the in-vehicle conversation. In response to receiving the user feedback, one or more conversation features may be adjusted by the subset AI unit during the in-vehicle conversation.

The method may further include receiving user input via a personalization user interface to adjust a level of personalization by choosing protected personal information to exclude from the first clean prompt. The first clean prompt maybe filtered to extract out the protected personal information.

In some implementations, a vehicle conversation system is provided, which includes at least one sensor in a vehicle of a user to capture in-vehicle conversation information and event information. A computing device is also provided and includes one or more processors and logic encoded in one or more non-transitory media for execution by the one or more processors. When the logic is executed, the logic is operable to perform various operations as described above in terms of the method. The operations include determining a user category that characterizes a user, based, at least in part, on anonymized user information.

The system computing device may further comprise a subset AI unit to perform various steps. Such steps may include determining a first conversation topic from a topic output of a subset AI unit that applies generalization rules for the user category, the in-vehicle conversation information, and the event information. Based, at least in part, on the user category and the first conversation topic, The subset AI unit may create a first clean prompt, to receive first enhancement information from a selected first external AI service. The subset AI unit may further provide at least one AI communicator.

At least one AI communicator may generate a first speech associated with the first conversation topic and using the first enhancement information. The AI communicator further may output the first speech in the vehicle.

In some implementations, a non-transitory computer-readable storage medium is provided which carries program instructions for facilitating an in-vehicle conversation using AI. These instructions when executed by one or more processors cause the one or more processors to perform operations as described above for the vehicle conversation method described above.

A further understanding of the nature and the advantages of particular embodiments disclosed herein may be realized by reference of the remaining portions of the specification and the attached drawings.

### BRIEF DESCRIPTION OF THE DRAWINGS

The disclosure is illustrated by way of example, and not by way of limitation in the figures in which like reference numerals are used to refer to similar elements.

FIG. 1 is a conceptual diagram illustrating a plan view of an example setting in which some aspects of the vehicle conversation system can be implemented, in accordance with some implementations.

FIG. 2 is a block diagram of an example of components of an environment that includes the vehicle conversation system, in accordance with some implementations.

FIG. 3 is a conceptual diagram illustrating an example of multiple AI communicators having individual personality types, in accordance with some implementations.

FIG. 4 is a conceptual diagram illustrating an example of choosing topics and subtopics for AI communicators, in accordance with some implementations.

FIG. 5 is a cylindrical graph representing to shift a conversation topic, in accordance with some implementations.

FIG. 6 is a conceptual diagram illustrating various examples of user controls, in accordance with some implementations.

FIGS. 7a-7b are conceptual diagrams illustrating examples of in-vehicle locations for AI communicators in floating positions, in which FIG. 7a shows AI communicators in front of the user, and FIG. 7b shows AI communicators surrounding the user, in accordance with some implementations.

FIGS. 7c-7d are conceptual diagrams illustrating examples of in-vehicle locations for AI communicators in floating positions, in which FIG. 7c shows the AI communicators proximal to the user and FIG. 7d shows the AI communicators spaced from the user, in accordance with some implementations.

FIGS. 8a-8b are conceptual diagrams illustrating examples of in-vehicle locations for AI communicators in seat positions, in which FIG. 8a shows an AI communicator filling all seats with a single user, and FIG. 8b shows AI communicators filling back seats with two front seat users, in accordance with some implementations.

FIGS. 8c-8d are conceptual diagrams illustrating examples of in-vehicle locations for AI communicators, in which FIG. 8c shows a single AI communicator filling a remaining seat with three users, and FIG. 8d shows a single AI communicator located at a front dash with four users filling all seats, in accordance with some implementations.

FIG. 9 is a flow diagram of the vehicle conversation process to create a personalized AI generated conversation with a user, in accordance with some implementations.

FIG. 10 is a flow diagram the vehicle conversation process in which a conversation topic is shifted, in accordance with some implementations.

FIG. 11 is a flow diagram of an example method for training an artificial intelligence (AI) model for use in predicting a conversation topic, in accordance with some implementations.

### DETAILED DESCRIPTION OF EMBODIMENTS

The present vehicle based conversation system enables AI generated conversations for entertainment in mobility contexts. A subset AI unit manages one or more AI communicators personalized to a user for the AI communicators to converse with each other and/or with the user in the vehicle. The conversation system may also provide various levels of protections for sensitive information of the user.

The conversation system employs a variety of context information to customize a conversation. An understanding of the user is attained by characterizing attributes of the user and deciding on a user category to associate with the user. Context information also includes user verbal cues embodied in conversation information, such as driver responses during a present conversation, as well as accessing information from previous conversations. The context information further includes event information for actions that occur in association with the user and/or vehicle as detected by one or more sensors. Conversation topics may be identified and AI speech generated based on the context information. In this manner, a conversation may be initiated by the conversation system and may evolve as additional information is gleaned.

Flexible conversation speech is adapted for the user and driving environment, which can be shifted on the fly in response to changing context information. In some implementations, the AI generated conversations may be dynamic in that topics can be shifted in real time during a conversation, for example, based on user responses, user feedback, or other user queues, vehicle information, and other sensor information, such as GPS data. The user may participate in the ongoing AI generated conversation, or simply listen in a passive manner. A feedback user interface can allow for flexibility in changing the conversation as preferred by the user.

The generated conversation may be made sophisticated by employing output from various external AI services on an as-needed basis, managed by the subset AI unit. All the while, user sensitive information can remain protected by the vehicle conversation system.

Personalization of the conversation make take place within spheres of protections against unwanted disclosure and use of sensitive information. At a front end of the personalization process flow, prior to information being fed into the subset AI unit, user information is anonymized, such as using zero knowledge proof methods. Non-authorized access to information can be provided via blockchain technology. Farther down the personalization process flow where the system interacts with external services, a prompt may be filtered to extract any personal user information prior to being provided to the external services.

Deep learning, e.g., neural network models, may be employed to learn complex patterns in information fed into AI models being employed, such as the subset AI unit and/or AI communicators, to predict user conversation preferences, such as conversation topics, and generate content, such as speech and prompts. Increasing amounts of information may be collected over time during the course of the user interacting with the vehicle conversation system, including sensors detecting user activity when in the vehicle whether or not the user is verbally interacting with an AI communicator. The added data may be fed into the conversation system to adjust aspects of the AI process, such as strength between types of information, and to further train the AI models to more accurately produce output. For example, an initial dataset may include basic or public profile information about a user that may be inputted by the user or collected by external sources. The datasets may be supplemented or replaced with added information collected by sensors including audio receivers.

A “user” of the vehicle conversation system as applied in this description, refers to at least one person in a vehicle that employs the conversation system, and which verbally interacts with the system. The user is often a driver of the vehicle, but may also be a passenger in the vehicle.

A “vehicle”, as used in this description, may include a variety of either real transport machines or virtual transport models (such as a virtual reality cockpit for a digital twin of a transport machine) that carries at least one person, including but not limited to ground vehicles such as cars, trucks, buses, mobility scooters, bicycles, etc. Watercraft vehicles may include ships, boats, underwater vehicles, etc. Aircraft vehicles may include airplanes, helicopters, aerostats, and vehicles may also include spacecrafts. A user driving such vehicles can include both real driving or virtual driving. Also, the personalized conversational AI environment may be deployed to an “immobilized enclosed space” such as a private room at an office, home, restaurant and so on by a client system such as a smartphone and wireless speakers to keep the conversation going.

The vehicle conversation system addresses issues that can arise when using other types of conversational AI systems. Often, a user needs to initiate or direct a response from a conversational AI service by the user presenting a question. Current conversational AI systems often require a user to register an account and commit to a dedicated platform in an enclosed ecosystem.

Conversational AI systems that interface with other AI services pose a risk to the user by inadequate safeguarding of sensitive information for the user. This vulnerability can make it difficult to gain user trust and poses challenges to achieving a personalized experience tailored to individual preferences.

The present vehicle conversation system not only addresses such protection concerns, but can also manage increased complexity with blending multiple AI personalities across various AI services. The vehicle conversation system has additional benefits that will be apparent by this description.

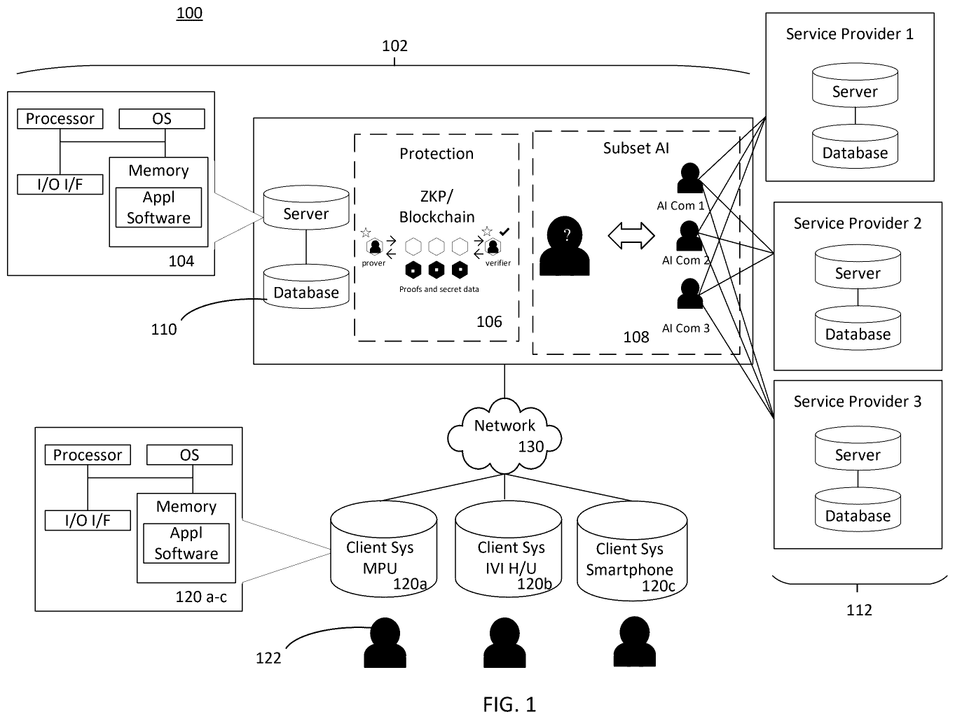

FIG. 1 shows an example of a vehicle conversation system 102 in a computing environment 100 having components to produce the vehicle-based AI conversations. One or more computing device(s), e.g., a server 104, executes at least some of the computer code involved in performing the vehicle conversation methods. A protection unit 106 provides security measures to enable use of non-sensitive user information. A subset AI unit 108 manages and performs processes to converse with the user, as discussed in detail below. The vehicle conversation system 102 may also include client devices 120a, 120b, 120c running software to interface with the user in a vehicle (and in some cases extended outside of the vehicle) and with the server 104 across network 130. The vehicle conversation system 102 further communicates with one or more external AI services 110 to retrieve specialized information for system generated speech.

The server 104, such as cloud computing device(s), includes familiar computer device components such as a processor, input/output interface(s), memory storing various application software for the methods presented in this description, and an operating system. The server 104 accesses one or more databases 110, which store information, such as user information, category information, event information (e.g., event memory), conversation information (e.g., conversation corpus), sensor data, and other data needed for the conversation processes. Event information may, for example, be associated with inside and outside environmental data, destination details, and the status of the user and other vehicle occupants.

Server 104 may be composed of one or more general purpose computers, specialized server computers (including, by way of example, PC (personal computer) servers, UNIX? servers, mid-range servers, mainframe computers, rack-mounted servers, etc.), server farms, server clusters, or any other appropriate arrangement and/or combination. In various embodiments, server may be adapted to run one or more services or software applications described in this description. For example, server may correspond to a server for performing processing described above according to an embodiment of the present disclosure.

The memory may include solid state memory in the form of NAND flash memory and storage media. The server 104 may include a microSD card for storage and/or may also interface with cloud storage server(s). The memory and storage media are examples of tangible non-transitory computer readable media for storage of data, audio files, computer programs, and the like. Other types of tangible media include disk drives, solid-state drives, floppy disks, optical storage media and bar codes, semiconductor memories such as flash drives, flash memories, random-access or read-only types of memories, battery-backed volatile memories, networked storage devices, cloud storage, and the like. A data store, e.g. database 110 as described below, may be employed to store various information.

Application software, when executed by one or more processors, is operable to perform various tasks of methods including generating personalized speech, determine conversation topics and parameters, etc., as described in this description. The computer programs may also be referred to as programs, software, software applications or code, may also contain instructions that, when executed, perform one or more methods, such as those described herein. The computer program may be tangibly embodied in an information carrier such as computer or machine readable medium, for example, the memory 604, storage device or memory on the processor. A machine readable medium is any computer program product, apparatus or device used to provide machine instructions or data to a programmable processor.

Server 104 further includes an operating system to control and manage the hardware and software of the server 104 with low latency in communication with one another. Any operating system, e.g., AI operating system, that supports the vehicle conversation methods including AI models may be employed.

One or more input/output interfaces may be enabled for wireless communication, such as via BLUETOOTH, BLUETOOTH Low Energy (BLE), radio frequency identification (RFID), etc. Wireless communication by the server may connect with other computing devices, such as a client device(s) 120a-c of the user, e.g., smartphone, smart watch, etc.

In some implementations, the server 104 may also include software that enables communications of I/O interface over a network such as HTTP, TCP/IP, RTP/RTSP, protocols, wireless application protocol (WAP), IEEE 802.11 protocols, and the like. In addition to and/or alternatively, other communications software and transfer protocols may also be used, for example IPX, UDP or the like. The communication network may include a local area network, a wide area network, a wireless network, an Intranet, the Internet, a private network, a public network, a switched network, or any other suitable communication network, such as for example Cloud networks.

Network(s) 130 used by various components of the vehicle conversation system 102 may be any type of network familiar to those skilled in the art that can support data communications using any of a variety of commercially available protocols, including without limitation TCP/IP (transmission control protocol/Internet protocol), SNA (systems network architecture), IPX (Internet packet exchange), AppleTalk, and the like. For example, network(s) 130 can be a local area network (LAN), such as one based on Ethernet, Token-Ring and/or the like. Network(s) 130 can be a wide-area network and/or the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth, and/or any other wireless protocol); and/or any combination of these and/or other networks.

The network 130 may include a local area network, a wide area network, a wireless network, an Intranet, the Internet, a private network, a public network, a switched network, cellular, wired connections, or any other communication network, such as for example Cloud networks, suitable for connecting the components. Network 130 may include a short-range connection between the client device and server 104, such as Bluetooth Low Energy (BLE) connection. Other connections are possible such as wide band and ultra-wide band.

In an example, one or more of the databases 110 may reside on a storage medium local to (and/or resident in) the server 104. Alternatively, database 110 may be remote from server 104 and in communication with server 104 via network 130 or a dedicated connection. In one set of embodiments, database 110 may reside in a storage-area network (SAN). Similarly, any necessary files for performing the functions attributed to server 104 may be stored locally on server 104 and/or remotely, as appropriate. In one set of embodiments, database 110 may include a relational database that is adapted to store, update, and retrieve data in response to computing language commands.

Server 104 utilizes user information that excludes sensitive user information. The system need not utilize such sensitive information that the user would not like to review, such as personal identifiable information by anonymizing the user information. Some anonymizing techniques use Zero Knowledge Proof (ZKP) methods. Some examples of ZKP methods that may be employed are described in U.S. Patent Publication No. 2022/0407706, published Dec. 22, 2022, and U.S. Patent Publication No. 2022/0035950, published Feb. 3, 2022, the contents of both patent applications are incorporated by herein by reference. For example, a user may register personal information with the conversation system or other systems that employ ZKP methods.

The ZKP method can use, for example, a distributed peer to peer (P2P) database distributed in a P2P network to manage the personal and sensitive information. In some implementations, the P2P database may include a blockchain system distributed in the P2P network. Such blockchain system may manage historical data (log) indicating a history of requests for and acquisition of personal recorded in the blockchain. Spoofing and falsification of user information may be prevented by giving a digital signature using an encryption key to each set of historical data or by encrypting each set of transaction data. Further, each set of historical data may be made public and shared by all of the information processing devices. The subset AI unit may manage multiple smart contracts, e.g., to automates the actions required in a blockchain transaction for the categorization.

A plurality of proofs may be generated based on each of the conditional expressions (hereinafter, appropriately referred to as a proof) as certification information used for verification using the zero-knowledge proof. The proof is information for proving, for example, that personal information satisfying the conditions specified by the user is known without disclosing the personal sensitive information. For example, the conversation system uses the verification key to verify the proof generated with the certification key.

Various client devices 120a-c may be employed to serve as interface (output and/or input) between the subset AI unit and the user 122. The client device 120a-c may be integrated with the user vehicle such as in-vehicle infotainment (IVI) system 120b and multimedia plug-in unit (MPU) 120a, or the client device may be portable, such as smartphone 120c, and carried into the vehicle for use with the conversation system 102. Client devices 120a-c may be computing devices dedicated for use with the conversation system, or may employ software to perform processes of the conversation system. Client devices 120a-c can use familiar computer device components such as a processor, input/output interface(s), memory storing various application software for the methods presented in this description such as interfacing with server 104 and the user(s), and an operating system, similar to the description above with regard to server 104.

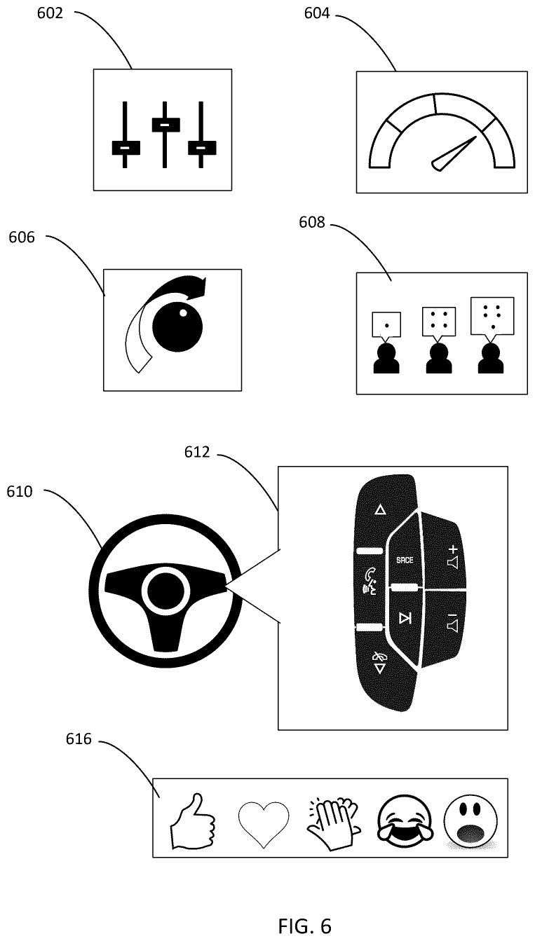

Client devices 120a-c may include a user interface that enables the user to input preferences and requests. In some implementations the user interface may display various control elements, such as control elements shown in FIG. 6 and described below. The client device may further include audio speaker(s) and receiver for the user to interact via voice with the conversation system 102.

The subset AI unit 108 performs various management processes, such as monitoring conversations of the user and AI communicators and create personality types for each AI communicator. The subset AI unit 108 further may pull data from various selected external AI services 112 on a necessity basis and monitors each transaction with the external AI services.

External AI services 112 can include various information providers, such as such as Spotify, Chat GTP, Command R, Perplexity, etc. The subset AI unit 108 can serve as a hub to the external AI services 112 for information as needed and deliver the information to AI communicators as necessary for generation of conversation speech. There is no need for the user to subscribe to each external service separately. The subset AI unit further can avoid the need for the user to provide personal sensitive information to the external AI services, such as personal identifiable information. In this manner, the subset AI unit provides efficiency in preventing unnecessary accounts.

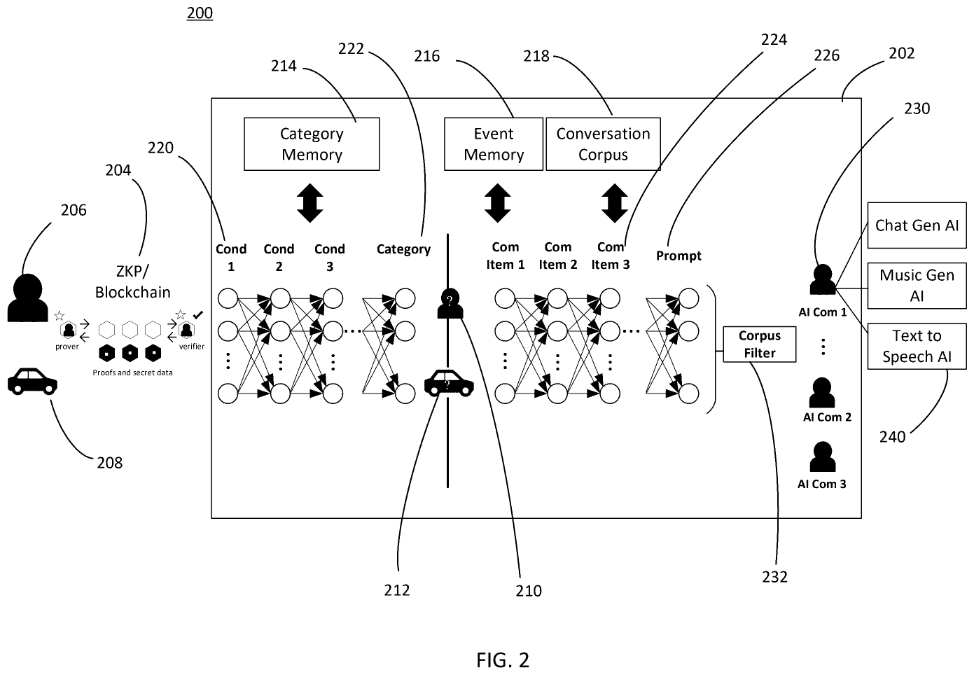

In some implementations, a single AI communicator is created and defined by the subset AI unit, to generate lines of speech in conversing with the user. In other implementations, multiple AI communicators may be created, defined, and selected by the subset AI unit to generate lines of speech to contribute to the conversation. Implementation of the AI communicator is described in detail below, for example, with reference to FIG. 2.

FIG. 2 shows a block diagram of an example of the vehicle conversation system 200 performing processes to create personalized conversations for the user 206. The processes can include anonymizing 204 user information 220 retrieved from a category memory 214 (e.g., as described above for FIG. 1) and used in characterizing the user 206 and vehicle 208 into a user category 222 that is applied, along with event information in event memory 216 and conversation information in corpus(es) 218 as communication items 224 to generate prompt(s) 226 and to generate conversation speech. The prompt(s) may be filtered 232 to exclude sensitive information and be submitted to various external AI services 240. Information retrieve from the external AI services 240 is received by AI communicators 230 to be use in generating the lines of conversation speech.

During the user categorization phase, characterizing of a user personality can be performed with anonymized user information and without extracting user personal sensitive information, including vehicle sensitive information, such that an anonymized user 210 and anonymized vehicle 212 are considered by the conversation system. In some implementations, the subset AI unit may apply generalization rules for the user category, in-vehicle conversation information, and event information to learn the underlying patterns and relationships in the information, rather than memorizing individual samples of information. By focusing on generalization, the subset AI unit can apply previously unknown information gained during the course of a user interacting with the conversation system, new event information, etc. Reliable predictions may be made under a variety of changing user and vehicle circumstances.

In some implementations, the subset AI unit 202 can manage the front end protective processes, such as ZKP and multiple smart contracts using blockchain technology, to create clean user information without involving sensitive information of the user. The clean user information (including vehicle information) may be stored in the category memory 214, e.g., as a user profile, to be retrieved as needed for a conversation involving the user. A predefined user category may also be stored in the category memory 214 and updated if needed to be changed.

In some implementations, more than one user may ride in the vehicle and be involved in a conversation. In cases of multiple users, respective user categories may be pulled from the category and incorporated into the conversation processes. In some implementations, weights may be associated with various users and respective user information. For example, user information for a driver may take priority over passenger information, information regarding a child may take priority upon request of the adult user where the adult user is interested a conversation appropriate for a particular age of the child. In some implementations, seated positions of a user in the vehicle may be a factor in weighing user information, such as higher weights for front seat users where the AI communicators are projected at the front of the car, and vice versa for back seat users. In some implementations, user information for multiple passenger users is ignored and only driver user information is employed in the conversation personalization process.

User information may include, for example, descriptions of the user such as demographic information, family status, education, employment, and other such information that does not readily identify the user. The user category may embody the diversity (type) of the user, as well as mobility capabilities. Diversity (user type) may be determined based on various conditions 220, e.g., user information, pulled from the category memory (e.g., user profile) that are descriptive of aspects of the user, such as user appearance, user tending to be outspoken or quiet, etc.

Vehicle related information may include descriptions of the vehicle, such as type (car, truck, train, boat, etc.), make, model, year, number of doors and seats, color, features, mobility capability, and other such descriptions that do not readily identify the vehicle as belonging to the user (such as VIN, registration, license plate number, registration address, etc.). This clean vehicle information can add to characterizing the user into a user category. For example, use of a company vehicle can indicate the user works while driving, a 4-wheel drive vehicle may indicate an adventurous user personality, a sports car may indicate a desire to drive fast, etc.

There are various groupings in which user categories may be defined by the conversation system. For example, a user may be categorizes as a Type A (e.g., high achiever), Type B (e.g., easy going), Type C (e.g., hostile), or Type D (e.g., anxious) personality. Other category groupings may include extrovert/introvert, sensing/intuition, thinking/feeling, and judging/perceiving. There are numerous other groupings of personality types.

Categorization of a user may be improved via machine learning and/or deep learning as the conversation information and event information get updated with new data from user interactions and event memories from conversations. The new information may be generalized case-by-case through machine learning or deep learning and integrated into a neural network of the subset AI unit. The neural network gets updated accordingly.

Once a user category is determined, as additional information is collected the category may be changed to better type the user. For example, given initial user information scraped from public sources a user category is defined and then as user conversation responses are captured, the conversation system may update the user category to better align with the user.

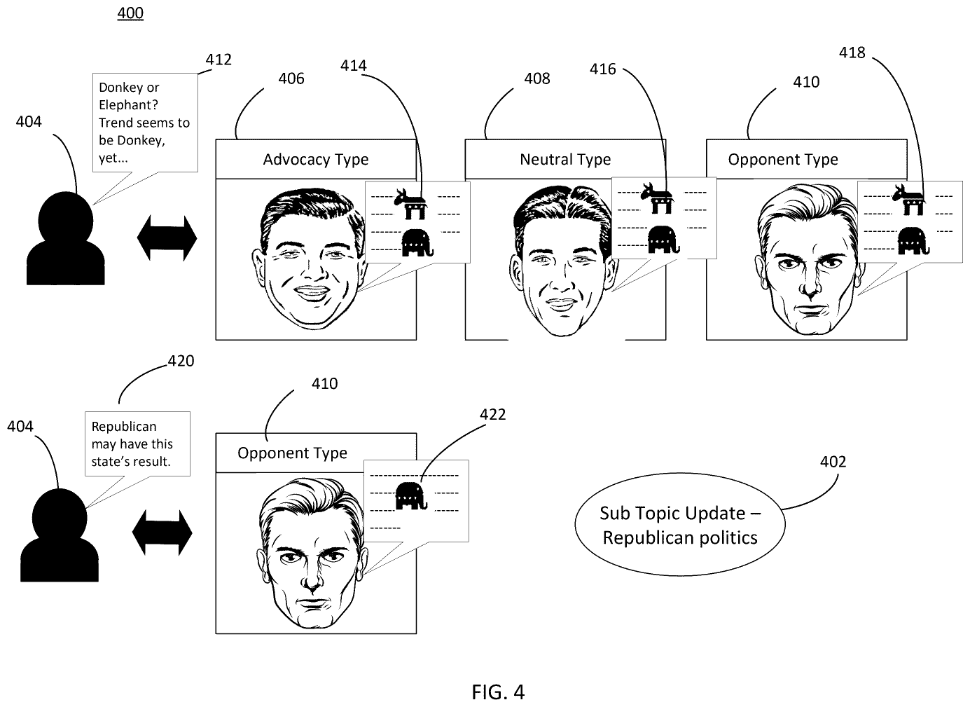

In a conversation topic phase, the AI subset unit predicts a conversation topic that is likely to interest the user by inputting event information and conversation information, as well as the user category. Rather than selecting a generic conversation topic or relying on the user to initiate a topic, through AI model training, the topic can be closely aligned with the interest of the user. The AI subset topic prediction model(s) is/are trained with datasets including common information for general users of the same or similar user category. In some implementations, an initial topic may be determined as a broad subject and as additional user-specific information is captured, the topic may be further defined to be more specific and tailored subtopics for the user. As described below with regards to examples in FIG. 4, subtopics A or B may be selected during the course of the conversation.

During the conversation, the subset AI unit receives as input event information including past and/or present events that that the user and/or vehicle experiences. Event information may include data form sensors. For example, sensors may detect vehicle location (e.g., GPS), traffic, environment, roadway conditions, destinations, vehicle speed, etc.

Conversation information may be stored in one or more conversation corpuses 218 accessible by the subset AI unit. Conversation corpus may include various forms of information associated with prior or current user conversations as detected by one or more audio sensors. The conversation information may include transcripts and/or summaries or other descriptions of such conversations.

The subset AI unit may analyze the course of a conversation to make management decisions on the conversation topic, which AI communicator to output speech next, conversation parameters (such as pace or tone of a conversation). The conversation information may enable tracking of a current conversation to add additional lines of speech and continue the conversation along a path consistent with a chosen conversation topic, or enable the subset AI to decide to change course to a different topic or related topic, depending, for example on the user response or lack of response (e.g., indicating a lack of interest in the topic by the user).

The conversation corpus 218 may additionally include previous conversation topics and/or lines of speech from the conversation. If a conversation is placed on pause, such as for the user to leave the vehicle to go to work, the subset AI unit may retrieve the last conversation information to continue the conversation where it left off or otherwise pursue follow up speech on the last conversation to take place. The conversation system may track specific conversation points to follow up with in a future conversation, For example, where a user talks about preparing to attend a meeting, when the user returns to the vehicle, the AI communicator may create speech asking about the meeting.

In some cases, analysis of the conversation information may detect one or more shift indicators to indicate that a user category may need to be changed and/or a current conversation topic should be modified. For example, a shift indicator in a user response to a round of speech may signal that a user desires change to a subtopic to delve with greater granularity on the main topic, or to switch subtopics (e.g., between A subtopic and B subtopic). In some cases, analysis of the user response may indicate a user desire to change to entirely change to a different conversation topic. In some implementations, shift indicators may be detected from other sensor data, such as image capture devices capturing user body language, such as boredom, that suggests a user desires to change topics.

In one analogous example for illustration purposes, the user may be compared to a feline and typed as a particular cat species, such as a tiger, lion, lioness, jaguar, house cat, etc. Diversity conditions for such a feline typing may include, for example, area that the cat is located, coat pattern, roar sound, etc. Event information may include mobility occurrences such as current area, speed of mobility, and environmental conditions.

An example is provided below to show normalizing a conversation to update a user category or conversation topic. The example employs the feline analogy, in which statements are analyzed to update an initial conversation topic of “hunting”, and user category of “Lioness”:
AI comm 1: “I really enjoy hiking and exploring the wilderness.”
AI comm 2 “Yeah, there's nothing like the thrill of a good hunt.”
User Response 1 (in opposition to AI comm1 and AI comm 2 comments) “I prefer enjoying a delicious meal that someone else has hunted.”

Update user category to “Lion” based on User Response 1 and change the conversation topic to “exercise”.
AI comm 1: “Staying fit is essential for those long adventures.”
AI comm 2: “Absolutely, strength and speed are crucial.”
User Response 2 “I, on the other hand, love just relaxing at home.”

Update user category to “House Cat.”
AI comm 1: “By the way, I love tuna, especially straight from the can.”
AI comm 2: “Yeah, it's their favorite treat, isn't it.”
User Response: “I couldn't agree more. Tuna is simply irresistible.”

The subset AI unit may analyze the above conversation speech and confirm the user category as a “House cat” and choose from conversation topics such as getting food from home.

The subset AI unit takes the user category and conversation topic along with event information and conversation information, to generate prompts for retrieving enhancement information from external AI services 240 for use in generating conversation speech. The prompts may be filtered 232 to extract personal information, such as telephone numbers, credit card information, user real name, etc. In some implementations, a personalization user interface may be employed to enable user input to adjust a level of personalization. The user may choose what type of protected personal information must be excluded from the first clean prompt. A variety of external AI services can be accessed, such as chat generative AI systems, music generative AI systems, text to speech AI services, etc.

Prompt generation may be improved via machine learning and/or deep learning as the conversation information and event information get updated with new data. The neural network gets updated accordingly. In this manner, increasingly better personalization can be realized.

The subset AI further determines one or more conversation features for one or more AI communicators 230 to create and output the resulting speech. Conversation features may include conversation mood, time for response (e.g., words per unit time, pace of the conversation, etc.). For each line of speech, the subset AI unit feeds into the individual AI communicators 230 the appropriate information.

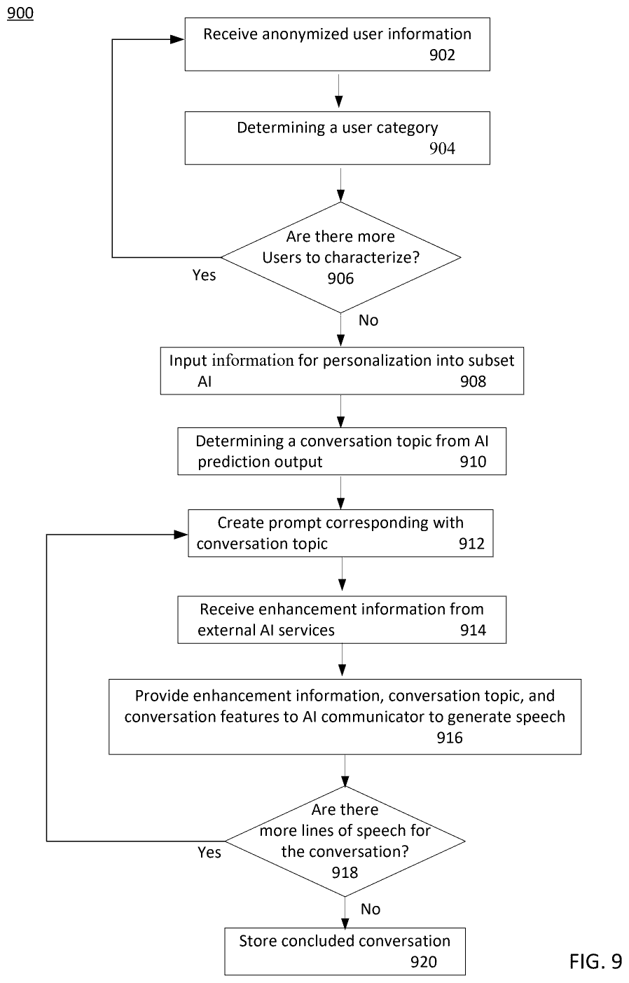

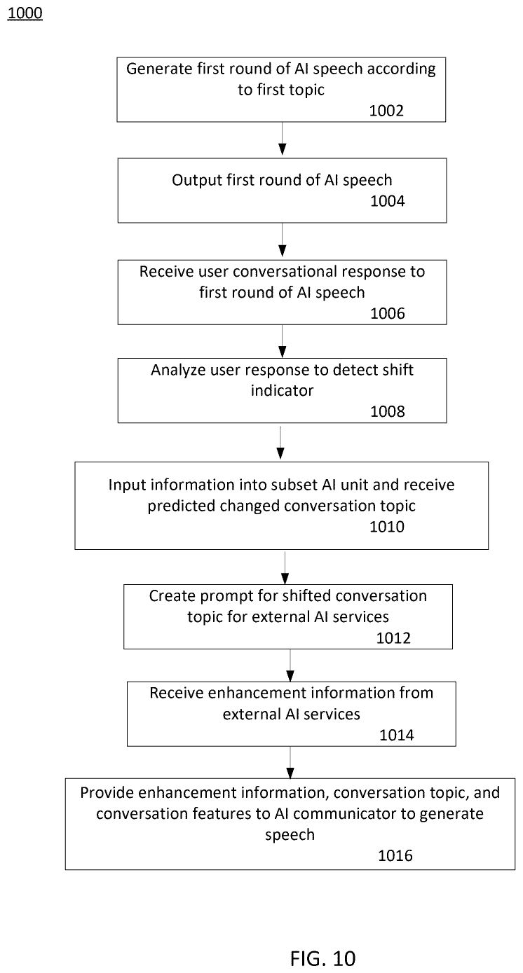

Other configurations of the conversation system 200 may be employed and are considered within the scope of this disclosure. Various designs and configurations of a vehicle conversation system 200 may be used. For example, in some implementations, a server need not be employed, other computing devices may be used such as a smartphone of the user, etc. Various other computing devices may include software applications to perform various of the vehicle conversation generation steps, as described in flow charts in FIGS. 9-10.

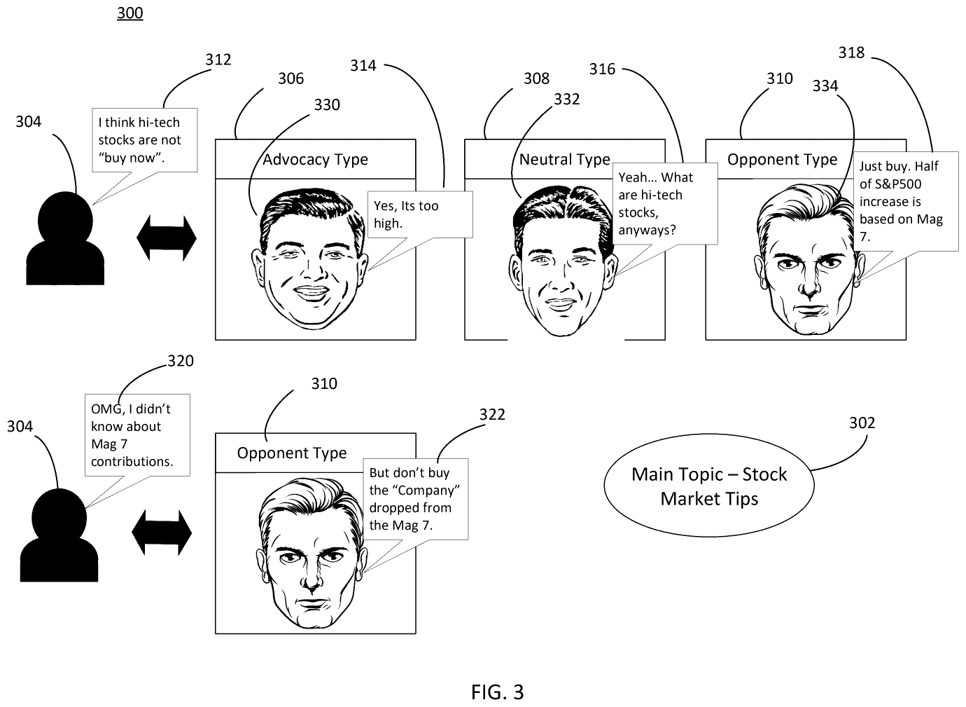

FIG. 3 illustrates an example of a process 300 to refine selection of an AI communicator personality type. In this example, a conversation topic 302 (“stock market tips”) is predicted to be of interest to a user 304, by applying user category, conversating information and/or event information as described above. In some implementations, AI communicators may be associated with corresponding images projected at a determined location in the user vehicle. AI communicators include advocate AI communicator 306 associated with a projected image 330, neutral AI communicator 308 associated with a projected image 332, and opponent AI communicator 310 associated with projected image 334. The illustrated conversation below may be a snippet of an ongoing or previously started conversation, or an onset of a new conversation started by user 304.

User 304 states 312, “I think hi-tech stocks are not “buy now.”
AI communicator 306 represents an advocacy personality type and responds 314 with a line of speech, “Yes, it's too high.”
AI communicator 308 represents a neutral personality type and also responds 316, “Yeah, what are hi-tech stocks, anyways?”
AI communicator 310 represents an opponent personality type and replies 318 in the conversation, “Just buy. Half of S&P500 increase is based on Mag 7.”
User 302 makes a second comment to 320, “OMG, I didn't know about Mag 7 contributions.”
[Based on the second comment 320, the subset AI determines that the user prefers the reply 318 and the opponent AI communicator 310 is chosen by the subset AI to continue with the conversation.]
AI communicator 310 responds 322, “But don't buy the “Company” dropped from the Mag 7.”

FIG. 4 illustrates an example of a process 400 to choose conversation topics and subtopics for AI communicators. Selection between various subtopics, such as A and B, may be based on user feedback to solve stochastic multi-armed bandit testing problems to encourage a right choice from a user to achieve efficient personalization of the conversations.

In the illustrated example, an initial conversation topic is predicted to be of interest to a user 404 and with the benefit of increasing conversation information, the topic is modified to a more specific subtopic that aligns with the user response(s) during the conversation. AI communicators include advocate AI communicator 406, neutral AI communicator 408, and opponent AI communicator 410. The illustrated conversation below may be a snippet of an ongoing or previously started conversation or an onset of a conversation started by user 404.

User 404 states 412, “Donkey or Elephant? Trend seems to be Donkey, yet . . . ” The subset AI unit may use external AI services to gain an interpretation of donkey to indicate US democratic party politics and elephant to indicate US republican party politics. Advocate AI communicator 406 responds 414 with a line of speech that is associated with both donkey and elephant political parties, neutral AI communicator responds 416 with a line of speech that is associated with both donkey and elephant political parties and opponent AI communicator 410 responds 418 with a line of speech that is associated with both donkey and elephant political parties.

In this illustration, user 404 makes a second comment to 420, “Republican may have this state's result.” The subset AI unit analyzes the user second comment to conclude that the user 404 is interested in discussing an update subtopic 402 regarding the republican political party. Based on the prior conversation in FIG. 3, the opponent AI communicator 410 is selected to continue the conversation subtopic 402 and the conversation corpus is updated with the new subtopic 402.

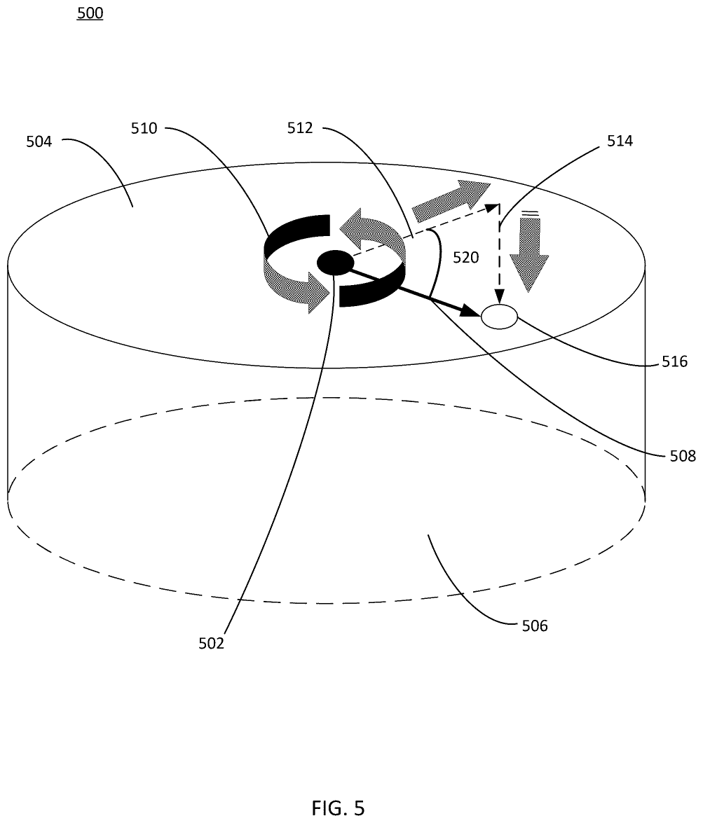

FIG. 5 shows a 3-D cylindrical graph 500 representing a process in terms of a vector to determine a shift in a conversation towards a changing topic relative to a user goal and practical solution. The conversation may be made engaging to the user by gradually directing speech around the topic, rather than making abrupt topic changes in the conversation.

In the 2-D cylindrical graph 500, a current conversation topic is denoted by solid point 502, which may lie on a top surface plane 504 of the cylindrical graph 500. The top surface 504 represents a user goal or intent of the user. A change in the conversation topic is represented by an open point 516 along vector 508 of the communication shift formed by direction.

Various factors may be balanced in the determination of the gradual topic shift. Balancing of factors include how much to talk toward particular considerations including a user goal 504, a practical solution 506, a direction to lead the talk, such as right circular denoted by circular arrows 510 or left circular. A practical solution, represented by bottom surface plane 506, may stand for essential points of a topic, such as the talk addressing when, where, who, what, why, and how about the goal topic.

Other factors to be balanced may include how much of a topic shift should occur, as represented by angle 520. For example, a user may comment on a topic “A” and the shifted topic may be chosen to relate to A, be a similar thing as A, or be anything else other than A, etc.

The length 514 represents how much the topic would be near the goal 504. For example, the user comments on the topic A and the topic shift may equate to 60-70% near to the topic “A” rather than the goal topic of “A” (representing 100% of the goal).

The user may be enabled to provide input into the conversation system to further personalize the conversation. Such user input may be in the form of user control requests in which the user changes conversation features during a conversation or prior to a conversation. In some implementations, user input may be in the form of feedback to convey user mood, such as likes, dislikes, shock, feeling a speech line is funny, etc., during the conversation, which may be considered by the conversation system to make adjustments to align conversation features including conversation topics and lines of speech with the user preferences on the fly during the conversation. In this manner, the user may achieve instant control of the conversation system by real time processing of feedback and/or storage of preferences for future conversations.

FIG. 6 illustrates various examples of user visual controls elements that maybe presented, such as on a feedback user interface, for the user to easily provide feedback to the conversation system without interrupting the act of driving. User feedback may be inputted during a conversation or after a conversation via one or more configurations of the visual control elements. Note that there may be other types of visual control elements in the vehicle, as well as other control elements that capture audio voice feedback by the user, and image capture sensors to capture user gestures that indicate user input.

Example of user control elements include individual slider elements 602 for each AI communicator, pointer gauge 604, rotating dial 606, individual icons for each AI communicator 608, steering wheel buttons 610 that may be programmed for user input, and displayed emojis 612. The control elements may be physical components inside of the vehicle, or displayed on one or more touch sensitive screens (e.g., driver screen, front passenger screen, back seat screen) in the vehicle in which the user touches the control element to provide user input.

Other control elements are possible to provide simple and quick feedback for the user to express desires. Control elements are typically easily accessible to a driver while the driver maintains focus on the act of driving. Control elements may include repurposing of current vehicle mechanical controls, such as buttons 610 and/or new keys or consol buttons. In some implementations, the user may input a number of clicks or touches, such as an up button to provide a level of positive feedback and one click indicating good, two clicks indicating better, more clicks indicating best. Likewise in this example, a down button may be used to input negative feedback, where one click indicates bad, two clicks indicate worse, and more clicks indicate worst.

Feedback input received by the user control elements may be applied to improve partial personalization and normalization of the neural network of the AI subset unit. Various conversation features may be controlled or otherwise be the subject of user feedback. For example, user input maybe provided for how much one or more AI communicators talk, such as talking occasionally, or requesting a number of words to be outputted for each AI communicator, e.g., via control elements individual sliders 602 and individual icons 608. Other controllable conversation features may include volume increase/decrease, fader which can control how lively the speech of the AI communicators appears, talking speed, number of AI communicators participating in a conversation, the persona of the AI communicator such as to imitate friends or family of the user, and other conversation features.

In some implementations, the user may select a persona of the AI communicator from a number of preconfigured personalities stored and available to the user. For example, the persona may be a person familiar to the user, such as family or friends. The persona may also be based on celebrities or public figures. Persona and speech lines are created within limitations and/or filters to comply with applicable laws. For example, the persona and voice may be presented in a manner so as to not confuse the user as to actual presence or talk of a particular person, endorsement by the person (or by consent of the person), etc.

User preferences received via the control elements may be stored for future personalization of conversations, such as conversation topic preferences stored in a topics profile for a user and conversation features.

In some implementations, the vehicle conversation system may select locations of AI communicator output in the vehicle. Audio output locations may be determined, for example, as described in U.S. Pat. No. 11,438,720, issued Sep. 6, 2022 and U.S. Pat. No. 11,432,094, issued Aug. 30, 2022, the contents both patents of which are incorporated by reference herein. AI communicator locations and arrangements may be selected based on various factors, such as sensor data like detected user positions, conversation topic, user preferences, potential driving distractions (e.g., driving on a highway during traffic vs a quiet street), etc. In some implementations, the vehicle is equipped with a single audio output source (e.g., speaker) for all AI communicators and no location decision is needed.

In some implementations a virtual image of a face of a character of each AI communicator may be projected into the vehicle at or near the audio output location. The projected face may be animated to appear to be speaking, which may be synchronized in time with output of the output of the lines of speech. Facial expressions of the projected faces may also correspond with a tone or subject matter of the outputted lines of speech. In some implementations, the user may employ augmented reality devices, such as glasses, to visualize the AI communicator characters.

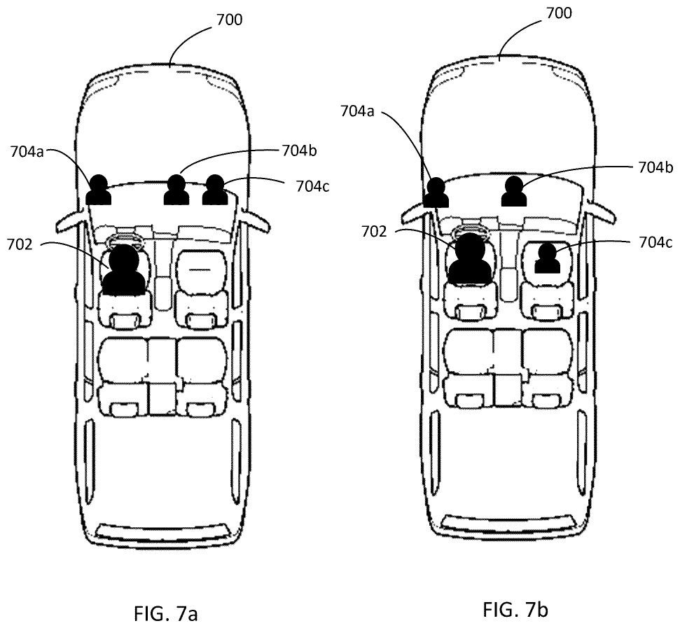

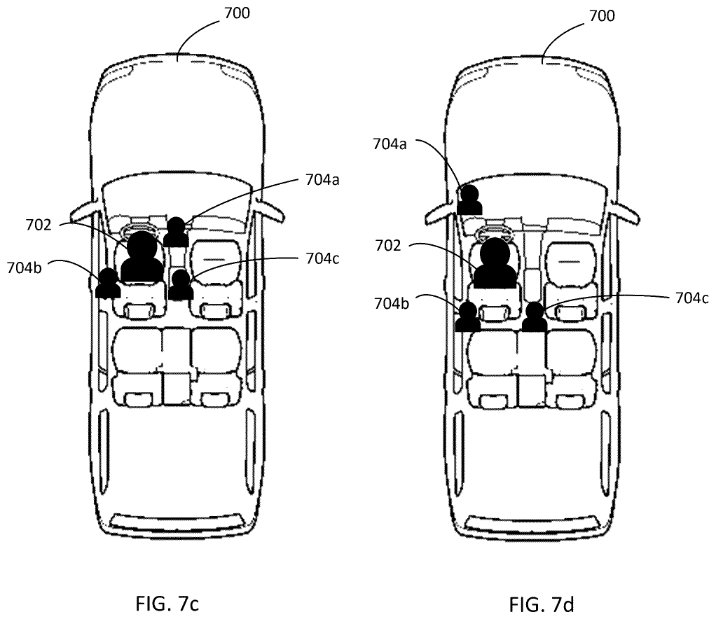

FIGS. 7a-7d show AI communicators arrangements of locations (placement of audio output and/or images) in a vehicle 700, where at least some of the AI communicators are in floating positions and placed relative to user location(s). For purposes of this description, the term “floating” refers to a location outside of a normal seat in a vehicle.

In FIG. 7a the AI communicators 704a, 704b.701c (referring to audio output and/or image projection) are positioned floating in front of the user 702. The AI communicators may include face images of the corresponding AI communicator projected on top of the dashboard of the vehicle. In this front arrangement, the driver need not divert eyes away from the road to view the AI communicator. In FIG. 7b the AI communicators are positioned around the user, where two AI communicators 704a, 704b are floating in front of the user/driver 702 and one 704c is in the front passenger seat. In FIG. 7c the AI communicators 704a, 704b.701c are positioned floating and proximal to the user 702. The near arrangement may be selected, for example, based on a conversation topic that is directed toward secrecy or sensitive subjects. In FIG. 7d the AI communicators are positioned floating and spaced surrounding the user with AI communicator 704a in front and AI communicators 704b, 704c behind the user 702.

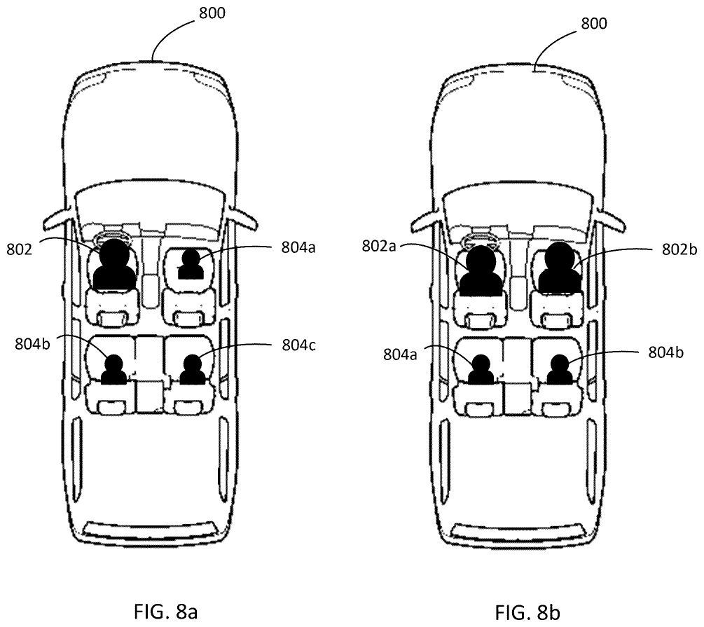

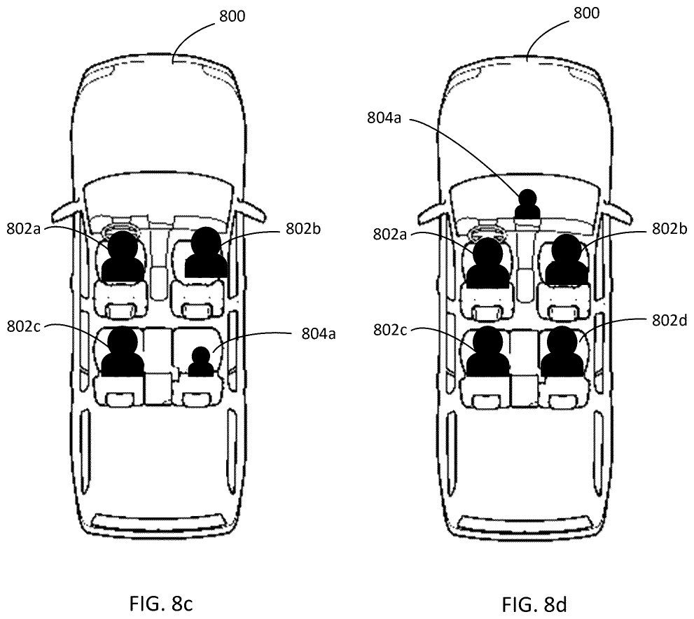

FIGS. 8a-8d illustrate examples of in-vehicle location arrangements for AI communicators where at least some of the AI communicators appear to be located (placement of audio output and/or images) in unoccupied vehicle seats. The conversation system may detect whether a passenger occupies a seat and avoids locating an AI communicator at that seat.

FIG. 8a shows a user 802 and filling unoccupied front seat with AI communicator 804a and two unoccupied back seats with AI communicators 804b, 804c. FIG. 8b shows two users 802a, 802b and AI communicators 804b, 804c filling the back seats. FIG. 8c shows a single AI communicator 804a filling a remaining seat with three users 802a, 802b, 802c. FIG. 8d shows a single AI communicator 804a located at a front dash with four users 802a, 802b, 802c, 802d filling all seats of the vehicle.

FIG. 9 shows a flow chart of some basic steps in the vehicle conversation process. The vehicle conversation process 900 may be performed by the subset AI unit such as item 108 shown in FIG. 1 and item 202 shown in FIG. 2.

In block 902, anonymized user information is received to apply to the personalization of conversation for a user. In some implementations, the anonymizing and other security processes (such as ZKP and blockchain methods) may be performed on the user information as protection measures of the vehicle conversation process 900. In this manner, the user information is ensured to be secure and verified for use.

In block 904, a user is characterized to determine a user category. For some conversations, a user category had been previously determined and stored by the vehicle conversation system and the stored user category is retrieved from a category memory.

In decision block 906, it is determined whether additional users are in the vehicle and require a user category to participate or listen to the conversation. Presence of of additional users may be detected with the use of various sensors in the vehicle that detect, for example, sound by a receiver, motion sensor, image capture device, touch sensor, seat pressure sensor (e.g., occupant classification system (OCS)), etc. In some implementations, a main user, e.g., driver, may enter into the conversation system a number of passengers. If more than one user is determined, the process may return to block 902 to receive user information associated with the additional user.

If no further users are present, the process continues to block 908, to input information into the subset AI unit to receive a prediction of a conversation topic. The input information may include a variety of information to facilitate personalization of the conversation topic.

In block 910, the conversation topic is determined, based at least in part on a predicted topic output from the AI topic model of the subset AI unit. The prediction suggests a conversation topic appropriate for the user. Other factors that may be considered in determining the conversation topic, in addition to the AI model topic prediction, may include newly occurring event information generated after the AI model prediction.

In block 912, to extract information for the conversation, select external AI services are solicited with one or more prompts created by the conversation process 900. The prompts correspond with conversation topic and AI communicators selected to participate in the conversation. Prior to transmitting the prompt(s) to the external AI services, the prompt may be cleaned of any sensitive information that a user does not desire to be shared with the external services.

In block 914, enhancement information is received from the various external AI services and processed for the AI communicators to generate speech. In some cases, the enhancement information may be incorporated directly into lines of speech. In other circumstances, the enhancement information may be used to determine speech, for example by changing a tone or wording of the enhancement information to suit the speech of a particular AI communicator.

In block 916, the enhancement information (processed or in raw form), the determined conversation topic, and various conversation features as determined by the subset AI unit, are inputted into respective AI communicator(s) to generate speech. The respective lines of speech for a first round are outputted by the respective AI communicator. The conversation may end based on sensor detected data or the user inputting a request to end the conversation. For example, conversation ending indicators may be detected, such as the vehicle has stopped, the vehicle arrived at a predefined destination, the user leaves the vehicle, a predefined time for the conversation has expired, etc.

In some implementations, an ending indicator may trigger a pause in the conversation to be continued later. In still some cases, the user may request that the conversation be transferred to a portable client device and the user can continue with the conversation outside of the vehicle. The client device may access the vehicle conversation system via a network/cloud arrangement.

In decision block 918, it is determined whether there should be additional lines of speech for additional rounds of the conversation. If the conversation is to continue, the process returns to block 912 to create additional lines of prompts for the same or different external AI services are used during the first round of the conversation. If is it determined that the conversation is ended and no more lines of speech is needed, the information regarding the conversation may be saved in the conversation memory. For example, a transcript of the outputted lines of speech and user responses, as well as other sensor data collected during the conversation, and conversation features, may be saved for future use.

FIG. 10 shows a flow chart of a vehicle conversation process 1000 in which a conversation topic shift is performed. The conversation shift process 1000 can be performed by the subset AI unit such as item 108 shown in FIG. 1 and item 202 shown in FIG. 2.

Steps taken prior to generating a first round of AI speech in block 1002, may be performed similar steps in blocks 902-916 in FIG. 9. Generating lines of speech according to a conversation topic in block 1002 and outputting the speech for a first round in block 1004 may also be performed similar or same as block 918 in FIG. 9.

In block 1006, a conversational response to first round of AI speech is received via audio receiver(s) in the vehicle. In block 1008, the user response may be analyzed to detect any shift indicators that suggest the user prefers the conversation topic to be modified.

In block 1010, information is inputted into subset AI unit and predicted changed conversation topic is outputted

In block 1012, one or more prompts are created for a shifted conversation topic for external AI services to provide enhancement information regarding the shifted topic. In block 1014, the enhancement information is received from the various external AI services. In block 1016, enhancement information, conversation topic, and conversation features are provided to AI communicator to generate speech on the shifted topic.

A shift indicator may include particular words or phrases that are known to suggest frustration, disagreement. In some implementations, a shift indicator may be a tone of the response may also be detected that indicates user desire to change topics. In some implementations, an image capture device directed at the user may pick up on body language or facial gestures that indicate the desire for a topic shift. Some implementations may request user input to confirm a desire to shift topics, such as an AI communicator outputting speech that requests user confirmation to shift topics.

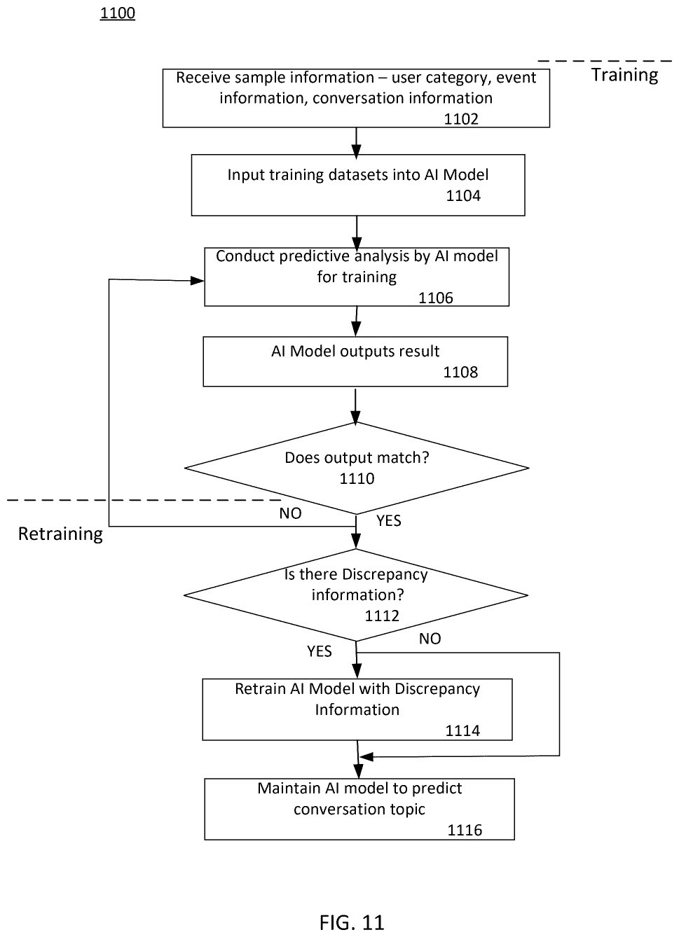

In some implementations, machine learning is employed to enable self-learning by analyzing training data sets and improve performance over time. FIG. 11 is a flow chart of an example training process for AI model(s) for the subset AI unit that may applied to determining conversation topics described above in FIGS. 9 and 10. The training and retraining steps may similarly be applied to other AI models in the conversation system, such as AI communicators to teach and refine generation of speech, determining user categories, generating prompts for external AI services, etc. In some implementations, the techniques to train the AI model may employ supervised classification algorithms, such as logistic regression algorithms. In some implementations, unsupervised or semi-supervised techniques may be employed.

In block 1102, sample various sample information for training datasets is received or otherwise accessed from storage for assessment/training purposes. The training information may include user category, event information, conversation information, etc. In block 1104, training datasets including the sample information are inputted into the AI model.

In block 1106, the AI model conducts predictive analysis using the training dataset. The training of the AI model may include analyzing trends and patterns in the sample information as related to various user categories that lead to positive predictive results. Based on the analysis, the AI model outputs a result of the analysis that predicts a conversation topic suitable for a particular sample situation, in block 1108.

In decision block 1110, the output result is compared with the training dataset inputted into the AI model and predetermined expected output result, to determine whether the output conversation topic result matches. It is determined whether a threshold of success is achieved by the output result. The threshold of success may specify that some value equal to or less than 100% accuracy (such as 80%-90% success rate) is acceptable output results to be used.

If it is decided in decision block 1110 that the output results match the training datasets to meet the threshold of success, the process continues. If there is a finding that the output results fail to match according to the threshold of success, the AI model is retrained by returning to block 1106 and conducting predictive analysis again until the output result matches the training dataset. If a match is not achieved after a threshold number of tries, the analysis algorithm and/or training dataset may be assessed to find a solution to the failures.

In decision block 1112, it is determined whether there is discrepancy information from prior AI model output results, in which the output of particular prompts was found to fail a threshold level of success in predicting conversation topics suitable for a user situation. Discrepancy information may include user feedback, user behavior, such as frequency of use of the conversation system, responses from an external support resource, quality control studies, user survey data, etc. The discrepancy information may be used for retraining in block 1114. After discrepancy information retraining is complete, the process proceeds to decision block 1116 described below.

If no discrepancy information is received, the process skips the discrepancy information retraining and continues to decision block 1116 to maintain the AI model for future use in outputting predicted conversation topics. In some implementations, the AI model may be trained at a computer processing system independent from the vehicle conversation system. The conversation system may receive or otherwise access the trained AI model upon detection of a user in the vehicle, user request to initiate a conversation, or other triggers.

Some or all of the training/retraining process 1100, or any other processes described herein, or variations and/or combinations of those processes, may be performed under the control of one or more computer systems configured with executable instructions and/or other data, and may be implemented as executable instructions executing collectively on one or more processors. In some implementations, training/retraining process 1100 may include additional steps.

The methods of FIGS. 9-11 described herein can be performed via software, hardware, and combinations thereof. The process may be carried out in software, such as one or more steps of the process carried out by the vehicle conversation system. Although the description has been described with respect to particular implementations thereof, these particular implementations are merely illustrative, and not restrictive.

Computer programs are employed and when executed by one or more processors, are operable to perform various tasks of methods including the vehicle conversation processes, as described above. The computer programs may also be referred to as programs, software, software applications or code, may also contain instructions that, when executed, perform one or more methods, such as those described herein. The computer program may be tangibly embodied in an information carrier such as computer or machine readable medium, for example, the memory, storage device or memory on processor. A machine readable medium is any computer program product, apparatus or device used to provide machine instructions or data to a programmable processor.

Any suitable programming language can be used to implement the routines of particular embodiments including IOS, Objective C, Swift, Java, Kotlin, C, C++, C#, JavaScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a non-transitory medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, etc. Other components and mechanisms may be used. In general, the functions of particular embodiments can be achieved by any means as is known in the art. Distributed, networked systems, components, and/or circuits can be used. Cloud computing or cloud services can be employed. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method for facilitating an in-vehicle conversation using artificial intelligence (AI), the method performed, comprising:
determining a user category that characterizes a user, based, at least in part, on anonymized user information;
determining a first conversation topic from a topic output of a subset AI unit that applies generalization rules for the user category, in-vehicle conversation information, and event information;
based, at least in part, on the user category and the first conversation topic, creating a first clean prompt, to receive first enhancement information from a selected first external AI service; and
generating a first speech associated with the first conversation topic and using the first enhancement information, for output in a vehicle by a first AI communicator.

2. The computer-implemented method of claim 1, wherein the first speech is AI generated by using as input the user category, the in-vehicle conversation information, and the event information.

3. The computer-implemented method of claim 1, further comprising:
selecting a second external AI service from a plurality of external AI services, as applicable to the first conversation topic and the user category; and
creating a second clean prompt to receive second enhancement information from the second external AI service,
wherein generating the first speech further uses the second enhancement information prior to outputting the first speech.

4. The computer-implemented method of claim 1, further comprising:
receiving a user response to output of the first speech;
determining a second conversation topic based, at least in part, on the user response; and
shifting the in-vehicle conversation by outputting a generated second speech associated with the second conversation topic.

5. The computer-implemented method of claim 1, further comprising:
anonymizing the user information and vehicle information by applying a zero knowledge proof method; and
storing the user information and the vehicle information in a blockchain.

6. The computer-implemented method of claim 1, further comprising:
determining a personality type for the first AI communicator suitable to interact with the user, based, at least in part, on the user category, the in-vehicle conversation information, and the event information,
wherein the first speech is generated to correspond with the personality type.

7. The computer-implemented method of claim 1, further comprising:
creating additional AI communicators, each having a determined individual personality type;
generating additional speech for the in-vehicle conversation corresponding to the respective individual personality type of the associated AI communicator; and
outputting the additional speech by individual of the respective additional AI communicators.

8. The computer-implemented method of claim 1, further comprising:
receiving user feedback via a feedback user interface in real time during the in-vehicle conversation; and
in response to receiving the user feedback, adjusting one or more conversation features by the subset AI unit during the in-vehicle conversation.

9. The computer-implemented method of claim 1, further comprising:
receiving user input via a personalization user interface to adjust a level of personalization by choosing protected personal information to exclude from the first clean prompt,
wherein creating the first clean prompt includes filtering out the protected personal information.

10. A vehicle conversational AI system, the system comprising:
at least one sensor in a vehicle of a user to capture in-vehicle conversation information and event information; and
a computing device comprising:
one or more processors; and
logic encoded in one or more non-transitory media for execution by the one or more processors and when executed operable to perform operations comprising:
determining a user category that characterizes a user, based, at least in part, on anonymized user information;
providing a subset AI unit to perform:
determining a first conversation topic from a topic output of a subset AI unit that applies generalization rules for the user category, the in-vehicle conversation information, and the event information;
based, at least in part, on the user category and the first conversation topic, creating a first clean prompt, to receive first enhancement information from a selected first external AI service; and
providing at least one AI communicator, wherein one of the at least one AI communicator performs:
generating a first speech associated with the first conversation topic and using the first enhancement information; and
outputting the first speech in the vehicle.

11. The vehicle conversational AI system of claim 10, wherein the first speech is AI generated by using as input the user category, the in-vehicle conversation information, and the event information.

12. The vehicle conversational AI system of claim 10, further comprising:
selecting a second external AI service from a plurality of external AI services, as applicable to the first conversation topic and the user category; and
creating a second clean prompt to receive second enhancement information from the second external AI service,
wherein generating the first speech further uses the second enhancement information prior to outputting the first speech.

13. The vehicle conversational AI system of claim 10, wherein multiple AI communicators are provided, the operations further comprising:
determining an individual personality type for each of the multiple AI communicators, each of the multiple AI communicators to perform:
generating additional speech for the in-vehicle conversation corresponding to the respective individual personality type of the associated AI communicator; and
outputting the additional speech by individual of the respective additional AI communicators, and
wherein the subset AI unit manages conversation features of each AI communicator.

14. The vehicle conversational AI system of claim 10, wherein the operations further comprise:
receiving a user response to output of the first speech;
determining a second conversation topic based, at least in part, on the user response; and
shifting the in-vehicle conversation by outputting a generated second speech associated with the second conversation topic.

15. The vehicle conversational AI system of claim 10, further comprising
a feedback user interface in the vehicle to receive feedback information from the user in real time during the in-vehicle conversation; and
in response to receiving the feedback information, adjusting one or more conversation features during the in-vehicle conversation.

16. A non-transitory computer-readable storage medium carrying program instructions thereon for facilitating an in-vehicle conversation using artificial intelligence (AI), the instructions when executed by one or more processors cause the one or more processors to perform operations comprising:
determining a user category that characterizes a user, based, at least in part, on anonymized user information;
determining a conversation topic from a topic output of a subset AI unit that applies generalization rules for the user category, in-vehicle conversation information, and event information;
determining a plurality of AI communicators having individual select personality types;
managing, by the subset AI unit, conversation features for each of the plurality of AI communicators;
creating, by the subset AI unit, clean prompts to receive enhancement information from selected external AI services for use in outputted speech by the plurality of AI communicators; and
generating a plurality of speech associated with the conversation topic using the enhancement information, for output in a vehicle by respective ones of the plurality of AI communicator.

17. The non-transitory computer-readable storage medium of claim 16,
wherein the respective speech is based, at least in part, on the user category and the conversation topic.

18. The non-transitory computer-readable storage medium of claim 16, wherein the operations further comprise:
sensing in-vehicle elements including locations of persons in the vehicle; and
determining a virtual location in the vehicle to output audio each of the AI communicators based in the in-vehicle elements including the locations of the persons.

19. The non-transitory computer-readable storage medium of claim 18, wherein the operations further comprise:
projecting a virtual character image associated with each of the AI communicators at or near the virtual location.

20. The non-transitory computer-readable storage medium of claim 16, wherein the operations further comprise:
receiving user input to control at least one conversation feature; and
in response to receiving the user feedback, adjusting one or more conversation features during the in-vehicle conversation.
